(19) United States
(12) Patent Application Publication
(10) Pub. No.: US 2006/0200511 A1
(43) Pub. Date: Sep. 7, 2006

(54) Channel equalizer and method of equalizing a channel

(76) Inventors: Sung-woo Park, Suwon-si (KR); Jong-soo Seo, Seoul (KR); Hae-joo Jeong, Seoul (KR); Jong-seob Baek, Seoul (KR)

Correspondence Address: STANZIONE & KIM, LLP, 919 18TH STREET, N.W., SUITE 440, WASHINGTON, DC, 20006, US

(21) Appl. No.: 11/363,179

(22) Filed: Feb. 28, 2006

(30) Foreign Application Priority Data
Mar. 4, 2005 (KR) 2005-18114

(51) Int. Cl. G06F 7/38

(52) U.S. Cl. 708/232

(57) ABSTRACT

A channel equalizer and a method of equalizing a channel. The channel equalizer includes a filter unit to filter an input training sequence signal and an input data signal according to a tap coefficient, a first multiplexer to calculate a priori error of each of the training sequence signal and the data signal, a decision unit to generate the training sequence signal and to soft-determine or hard-determine an output signal of the filter unit, an error signal generation unit to generate a priori error signal using an output signal of the decision unit and to generate an estimated posteriori error signal using the priori error signal, a first correction unit to correct a first adaptive step size algorithm using the signal input to the filter unit and the generated priori error signal and to correct a second adaptive step size algorithm using the signal input to the filter unit and the estimated posteriori error signal, and a second multiplexer to select one of the corrected first adaptive step size algorithm and the corrected second adaptive step size algorithm to be applied to the training sequence signal and the data signal, respectively.

### CROSS-REFERENCE TO RELATED APPLICATIONS

This application claims the benefit of Korean Patent Application No. 2005-18114, filed on Mar. 4, 2005 in the Korean Intellectual Property Office, the disclosure of which is incorporated herein by reference in its entirety.

### BACKGROUND OF THE INVENTION

1. Field of the Invention

The present general inventive concept relates to a channel equalizer and a method of equalizing a channel, and in particular, to a channel equalizer and a method of equalizing a channel by adaptively removing interference between symbols.

2. Description of the Related Art

A digital TV can receive an original signal without any distortion resulting from noise in transit, because video and audio signals are converted to digital signals and are then transmitted to a receiver, unlike in an analog TV. Additionally, a digital transmission can also transmit more data on a transmission channel having the same band as compared to an analog transmission, because compression and expansion of the video and audio data of the digital signals can be performed.

A vestigial sideband (VSB) technique is a conversion technique used with a complete digital High Definition TV (HDTV) having a simple hardware for processing data, because a signal has a one-directional constellation. However, a distance between signals is short causing interference to occur between symbols in the signals. Thus, a modulation and demodulation system used to modulate and demodulate the signals becomes more complex.

A signal transmitted from a transmission end to a receiving end has several distortions that are introduced via the transmission channel. In particular, a multi path has a substantial amount of interference between the symbols of the signals due to a phase change and a time delay of the transmitted signal, so that the substantial amount of interference causes bit detection errors at the receiving end. As such, a channel equalization method is used to reduce the bit detection errors at the receiving end by compensating for distortions occurring due to an abnormal transmission channel.

The transmission channel is variable because of several factors including a position of a transceiver, a distance of the transceiver, and a topology of the transceiver. The channel equalization method can adaptively compensate for a varying transmission channel environment by performing an adaptive channel equalization method.

The channel equalization method produces a low Mean Square Errors (MSE), and can effectively compensate for distortions occurring due to the transmission channel by increasing a convergence rate of an algorithm used in the channel equalization method, in response to an increase in a step size used to adjust the convergence rate.

However, both techniques (i.e., the channel equalization method and the adaptive channel equalization method) described above, have a low convergence rate when low MSEs are produced, and high MSEs when a high convergence rate is produced, so that the two conditions (i.e., high convergence rate and a low MSE) can not be satisfied at the same time.

### SUMMARY OF THE INVENTION

The present general inventive concept provides a channel equalizer and a method of equalizing a channel which can equalize the channel by adaptively removing interference between symbols occurring between the channels using a priori error and an estimated posteriori error.

Additional aspects of the present general inventive concept will be set forth in part in the description which follows and, in part, will be obvious from the description, or may be learned by practice of the general inventive concept.

The foregoing and/or other aspects of the present general inventive concept are achieved by providing a channel equalizer, which includes a filter unit to filter an input training sequence signal and an input data signal according to a tap coefficient, a decision unit to generate the training sequence signal and to soft-determine or hard-determine an output signal of the filter unit, a first multiplexer to calculate a priori error of each of the training sequence signal and the data signal, an error signal generation unit to generate a priori error signal using an output signal of the first multiplexer, and to generate an estimated posteriori error signal using the priori error signal, a first correction unit to correct a first adaptive step size algorithm using the signal input to the filter unit and the generated priori error signal and to correct a second adaptive step size algorithm using the signal input to the filter unit and the estimated posteriori error signal, and a second multiplexer to select one of the corrected first adaptive step size algorithm and the corrected second adaptive step size algorithm to be applied to the training sequence signal and the data signal, respectively.

The channel equalizer may further include a second correction unit to correct a first Least Mean Square (LMS) algorithm using the generated priori error signal and an adaptive step size and to correct a second LMS algorithm using the estimated posteriori error signal and the adaptive step size, and a third multiplexer to select one of the corrected first LMS algorithm and the corrected second LMS algorithm to be applied to the training sequence signal and the data signal, respectively.

The error signal generation unit may estimate a posterior error based on the priori error signal, a norm of data filtered by the filter unit, and a step size.

The step size may be updated to the adaptive step size by the second adaptive step size algorithm using the generated estimated posteriori error signal and the signal input to the filter unit.

The first correction unit may correct the second adaptive step size algorithm using the generated estimated posteriori error signal, the signal input to the filter unit, and the adaptive step size.

The second correction unit may correct the second LMS algorithm using the generated estimated posteriori error signal, the signal input to the filter unit, and the step size.

A first adaptive step size LMS algorithm that uses the priori error and a second adaptive step size LMS algorithm that uses the estimated posteriori error may be sequentially applied.

The first adaptive step size LMS algorithm and the second adaptive step size LMS algorithm may be applied in bounds of the training sequence signal and the data signal, respectively.

The foregoing and/or other aspects of the present general inventive concept are also achieved by providing a channel equalizer to equalize a channel, comprising a filter unit to filter an input signal and having a current plurality of tap coefficients, and the input signal having a training sequence portion and a data portion, and a correction unit to adjust the current plurality of tap coefficients according to a first adaptive step size LMS algorithm based on a priori error of the input signal when the data portion of the input signal is received by the filter unit, and adjusting the current plurality of tap coefficients according to a second adaptive step size LMS algorithm based on an estimated posteriori error of the input signal when the training sequence portion of the input signal is received by the filter unit.

The foregoing and/or other aspects of the present general inventive concept are also achieved by providing a channel equalizer to equalize a channel, comprising a filter unit to receive an input signal X(n) as one of a training sequence signal and a data signal and to filter the input signal according to a plurality of filter taps, an error signal generation unit to determine a priori error signal e^{a}(n) for the filtered input signal and to determine an estimated posteriori error signal E^{p}(n) according to the determined priori error signal e^{a}(n), and a correction unit to adjust a plurality of tap coefficients associated with the plurality of filter taps according to w(n+1)=w(n)+μ(n)*e^{a}(n)*X(n) when the training sequence signal is received by the filter unit where w(n+1) represents the adjusted plurality of tap coefficients, w(n) represents a current plurality of tap coefficients, μ(n) represents an adaptive step size, and adjusting the plurality of tap coefficients associated with the plurality of filter taps according to w(n+1)=w(n)+μ(n)*E^{p}(n)*X(n) when the data signal is received by the filter unit.

The foregoing and/or other aspects of the present general inventive concept are also achieved by providing a digital broadcast receiver, comprising a channel equalizer to equalize a channel, the channel equalizer including a filter unit to filter an input signal and having a current plurality of tap coefficients, and the input signal having a training sequence portion and a data portion, and a correction unit to adjust the current plurality of tap coefficients according to a first adaptive step size LMS algorithm based on a priori error of the input signal when the data portion of the input signal is received by the filter unit, and adjusting the current plurality of tap coefficients according to a second adaptive step size LMS algorithm based on an estimated posteriori error of the input signal when the training sequence portion of the input signal is received by the filter unit.

The foregoing and/or other aspects of the present general inventive concept are also achieved by providing a method of equalizing a channel, the method including filtering an input training sequence signal and a data signal according to a tap coefficient, calculating a priori error using the training sequence signal, updating a step size using the calculated priori error and the input training sequence signal, correcting the tap coefficient by applying a first LMS algorithm using the calculated priori error, and storing the corrected tap coefficient.

The method may further include soft-determining/hard-determining the input data signal and calculating the priori error, estimating a posteriori error using the calculated priori error and the input data signal, updating the step size using the estimated posteriori error and the input data signal, and correcting the tap coefficient by applying a second LMS algorithm using the estimated posteriori error.

The foregoing and/or other aspects of the present general inventive concept are also achieved by providing a method of equalizing a channel, the method comprising filtering an input signal having a plurality of symbols in a filter unit having a current plurality of tap coefficients, and the input signal having a training sequence portion and a data portion, and adjusting the current plurality of tap coefficients according to a first adaptive step size LMS algorithm based on a priori error of the input signal when the data portion of the input signal is received by the filter unit, and adjusting the current plurality of tap coefficients according to a second adaptive step size LMS algorithm based on an estimated posteriori error of the input signal when the training sequence portion of the input signal is received by the filter unit.

The foregoing and/or other aspects of the present general inventive concept are also achieved by providing a method of equalizing a channel, the method comprising receiving an input signal X(n) as one of a training sequence signal and a data signal, filtering the input signal according to a plurality of filter taps, determining a priori error signal eₐ(n) for the filtered input signal, determining an estimated posteriori error E^{p}(n) signal according to the determined priori error signal e^{a}(n), and adjusting a plurality of tap coefficients associated with the plurality of filter taps according to w(n+1)=w(n)+μ(n)*e^{a}(n)*X(n) when the training sequence signal is received where w(n+1) represents the adjusted plurality of tap coefficients, w(n) represents a current plurality of tap coefficients, μ(n) represents an adaptive step size, and adjusting the plurality of tap coefficients associated with the plurality of filter taps according to w(n+1)=w(n)+μ(n)* E^{p}(n)*X(n) when the data signal is received.

The foregoing and/or other aspects of the present general inventive concept are also achieved by providing a method of equalizing a channel, the method comprising receiving and filtering an input signal according to a plurality of tap coefficients, and applying a first adaptive step size LMS algorithm to the plurality of tap coefficients when operation of a filter unit is in an initial bound of convergence and applying a second adaptive step size LMS algorithm to the plurality of tap coefficients when the operation of the filter unit is in a subsequent bound of convergence.

The foregoing and/or other aspects of the present general inventive concept are also achieved by providing a computer readable medium containing executable code to equalize a channel, the medium comprising a first executable code to filter an input training sequence signal and a data signal using a tap coefficient, a second executable code to calculate a priori error using the training sequence signal, a third executable code to update a step size using the calculated priori error and the input training sequence signal, a fourth executable code to correct the tap coefficient by applying a first LMS algorithm using the priori error, and a fifth executable code to store the corrected tap coefficient.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a block diagram illustrating a channel equalizer in accordance with an embodiment of the present general inventive concept;

FIG. 2 is a flow chart illustrating a method of equalizing a channel in accordance with an embodiment of the present general inventive concept;

FIG. 3 is a table illustrating a steady-state mean squared error (MSE) result comparison of various adaptive algorithms;

FIG. 4 is a graph illustrating convergence curves of a channel equalizer in a time-invariant channel; and

FIG. 5 is a graph illustrating convergence curves of a channel equalizer in a time-variant channel.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

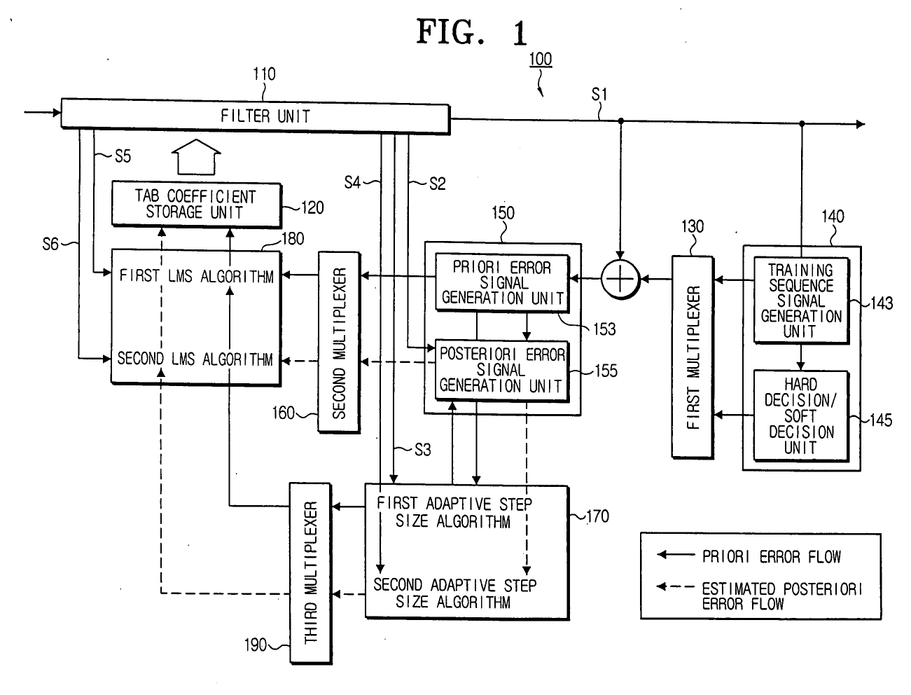

FIG. 1 is a block diagram illustrating a channel equalizer 100 in accordance with an embodiment of the present general inventive concept.

Referring to FIG. 1, the channel equalizer 100 includes a filter unit 110, a first multiplexer 130, a decision unit 140, an error signal generation unit 150, a first correction unit 170, a second multiplexer 160, a second correction unit 180, and a third multiplexer 190.

The filter unit 110 has a Tapped Delayed Line structure, and filters an input training sequence signal and an input data signal in response to tap coefficients stored in a tap coefficient storage unit 120. The first multiplexer 130 can be used to calculate a priori error signal of each bound of the training sequence signal and each bound of the data signal. The first multiplexer 130 can then provide the calculated priori error signal to the error signal generation unit 150 such that a posteriori error signal can be calculated accordingly thereby. The training sequence signal and the data signal may include bound information indicating upper and lower limits thereof. The bound of the training sequence signal and the data signal may represent a period of data in each signal. The priori error represents an error (filter tap coefficient error) on the upper and lower limits of the training sequence signal and the data signal.

The filter unit 110 outputs S1, S2, S3, S4, S5, and S6. Output S1 represents a signal that is filtered according to the tap coefficients. Outputs S1 through S5 represent an unfiltered signal that is input to the filter unit 110. The outputs S1 and S5 are used in various calculations within the channel equalizer 100. The decision unit 140 has a training sequence signal generation unit 143 and a hard decision/soft decision unit 145. The training sequence signal generation unit 143 generates the training sequence signal from the output signal S6 of the filter unit 110, and the hard decision/soft decision unit 145 hard-determines or soft-determines an output signal filtered by the filter unit 110. The hard decision/soft decision unit 145 decodes symbols of the filtered signal output by the filter unit 110 according to error probabilities thereof. The first multiplexer 130 selects either an output signal of the training sequence signal generating unit 143 or an output signal of the hard decision/soft decision unit 145. In other words, the training sequence signal generation unit 143 only creates and stores a training sequence signal. If there is a training sequence signal among signals filtered by the filter unit 110, the first multiplexer 130 selects and outputs the training sequence signal instead of a hard-determined/soft-determined signal.

The error signal generation unit 150 includes a priori error signal generation unit 153 and a posteriori error signal generation unit 155. The priori error signal generation unit 153 generates the priori error signal using an output signal of the decision unit 140 and selected (calculated) by the first multiplexer 130 and/or the output signal S1 of the filter unit 110, and the posteriori error signal generation unit 155 generates an estimated posteriori error signal using the generated priori error signal and/or the output signal S2 of the filter unit 110. The filter unit 110 provides the output signal S2, which is actually a signal input thereto (i.e., an unfiltered signal), to the posteriori error signal generation unit 155 such that the posteriori error signal generation unit 155 can calculate an estimated posteriori error of the posteriori error signal using the signal input to the filter unit 110 (i.e., the output signal S2) and a step size. That is, the posteriori error is estimated according to the priori error signal, a norm of data input to the filter unit 110 (received in the output signal S2), and the step size used to perform the filtering operation by the filter unit 110.

The correction unit 170 corrects a first adaptive step size algorithm using the output signal S3 of the filter unit 110, which is the unfiltered signal input to the filter unit 110, and the priori error signal generated by the priori error signal generation unit 153, and corrects a second adaptive step size algorithm using the output signal S4 of the filter unit 110, which is the unfiltered signal input to the filter unit 110, the estimated posteriori error signal generated by the posteriori error signal generation unit 155, and an adaptive step size updated by a step size algorithm.

The second multiplexer 160 selects an LMS algorithm to be applied to each of the training sequence signal and the data signal. That is, the second multiplexer 160 selects between the corrected first LMS algorithm and the corrected second LMS algorithm, respectively, to be applied to each of the training sequence signal and the data signal by providing one of the priori error signal and the posterior error signal, respectively, output from the priori error signal generation unit 153 and the posteriori error signal generation unit 155 to the second correction unit 180.

The second correction unit 180 corrects a first Least Mean Square (LMS) algorithm using the step size and the priori error signal generated by the priori error signal generation unit 153 using the step size, the priori error signal, and/or the output signal S5 of the filter unit 110 (i.e., the unfiltered input signal of the filter unit 110), and corrects a second LMS algorithm using the step size, the estimated posteriori error signal generated by the posteriori error signal generation unit 155, and the output signal S6 of the filter unit 110 (i.e., the unfiltered input signal of the filter unit 110). The first LMS algorithm uses the priori error generated by the priori error signal generation unit 153, and the second LMS algorithm uses the posteriori error signal generated by the posteriori error signal generation unit 155.

The third multiplexer 190 selects between the corrected first adaptive step size algorithm and the corrected second adaptive step size algorithm to be applied to each of the training sequence signal and the data signal, respectively. The second multiplexer 160 and the third multiplexer 190 may operate simultaneously to update the tap coefficient using the first LMS algorithm and the priori error signal when a signal filtered by the filter unit 110 is a training sequence, and to update the tap coefficient using the second LMS algorithm and the posteriori error signal when the signal filtered by the filter unit 110 is other than the training sequence.

The channel equalizer 100 sequentially applies the first adaptive step size LMS algorithm using the priori error determined by the priori error signal generation unit 150 and the second adaptive step size LMS algorithm using the posteriori error estimated by the posteriori error signal generation unit 155. Additionally, the channel equalizer 100 applies the first adaptive step size algorithm to the training sequence signal bound and the second adaptive step size algorithm to the data signal bound, which are input to the filter unit 110. In other words, the first adaptive step size algorithm and the first LMS algorithm are applied to the training sequence signal (i.e., the first adaptive step size LMS algorithm), and the second adaptive step size algorithm and the second LMS algorithm (i.e., the second adaptive step size LMS algorithm) are applied to the data signal.

The channel equalizer and the method of equalizing the channel using an adaptive channel equalization algorithm where the priori error and the estimated posteriori error are combined in accordance with the present embodiment are suitable for a packet type system in which a transmission signal includes the training sequence signal and the data signal.

The adaptive channel equalization algorithm applied in an embodiment of the present general inventive concept will be described with reference to equations 1 to 12 below.

The adaptive channel equalization algorithm, which updates N filter tap coefficients using a stochastic gradient method, is represented by equation 1.

In this case, w(n)=[w₁(n), . . . , w_{N}(n)]^{T} represents N tap coefficients, X(n)=[x₁(n), . . . , x_{N}(n)]^{T} represents N data vectors which have been transmitted via the transmission channel at the n^{th} time, ƒₑ(n) represents an estimated error function of the filter unit 110, μ represents the step size by which to adjust convergence characteristics of the adaptive channel equalization algorithm, and w(n+1) represents updated tap coefficient(s).
w(n+1)=w(n)+μƒₑ(n)X(n) Equation 1

Equation 2 (below) represents the priori error used in the first LMS algorithms. In this case, d(n) represents the training sequence signal, and w^{T}(n)X(n) represents the signal which is soft-determined or hard-determined with respect to the output signal from the filter unit 110.
eₐ(n)=d(n)−w^{T}X(n) Equation 2

The algorithm that updates the step size using the priori error calculated in equation 2 is derived using a stochastic gradient method in order to obtain a power of the priori error, that is, the step size is adjusted such that eₐ²(n) is minimized.

Equation 3 represents the first adaptive step size algorithm using the priori error. In this case, ρ^{SGA-GA} represents a step constant to adjust the convergence characteristics in the first adaptive step size algorithm, and (μₘᵢₙ, μₘₐₓ) represents a bound (i.e., upper and lower limits) of the step size μ. Accordingly, the first adaptive step size algorithm is performed to adjust the step size according to the prior error.
μ(n)=[μ(n−1)+ρ^{SGA-GA}eₐ(n)eₐ(n−1)X^{T}(n)X(n−1)]_{μ}_{ₘᵢₙ}^{μ}^{ₘₐₓ} Equation 3

The first adaptive step size LMS algorithm is expressed as equation 4 below by replacing the priori error eₐ(n) of equation 2 and the adapted step size μ(n) of equation 3 with ƒₑ(n) and μ of equation 1.
w(n+1)=w(n)+μ(n)eₐ(n)X(N) Equation 4

The first LMS algorithm and the first adaptive step size algorithm using the priori error eₐ(n) described in the above-described equations 2 to 4 are applied to the training sequence signal d(n).

The adaptive step size LMS algorithm including the second LMS algorithm that uses the estimated posteriori error and the second adaptive step size algorithm is used for the data signal. The second LMS algorithm applied to the data signal, the second adaptive step size algorithm, and the adaptive step size LMS algorithm of the present embodiment will be described with reference to equations 5 to 12 below.

Equation 5 (below) represents the posteriori error eₚ(n).
eₚ(n)=d(n)−w^{T}(n+1)X(n) Equation 5

In equation 5, the updated tap coefficient(s) w(n+1) is defined by equation 4. It can be seen from equation 4 that the posteriori error eₚ(n) depends on eₐ (n),X(n).

However, in order to detect the posteriori error eₚ(n) of equation 5, the updated tap coefficient(s) w(n+1) should be updated using equation 1, which means that the tap coefficient of the filter unit 110 for the (n+1)^{th} input signal is already corrected. Accordingly, the posteriori error cannot be directly applied to equation 1, and the calculation of the posteriori error eₚ(n) requires many operations.

Equation 6 (below) represents the estimated posteriori error E^{p}(n). In this case, ∥X(n)∥ represents a norm of the data vectors X^{T}(n) input to the filter unit 110, and γ(n) represents a reflected coefficient. Equation 6 is obtained such that that both sides of equation 4 are multiplied by the data vectors X^{T}(n), and the training sequence signal d(n) is subtracted therefrom, and equations 2 and 5 are applied thereto and developed.
Eₚ(n)=eₐ(1−μ∥X(n)∥)=eₐγ(n) Equation 6

In equation 6, when the step size, p, is smaller than 1/∥X(n)∥, the estimated posteriori error E^{p}(n) is always smaller than the priori error eₐ(n), and has a low mean squared error (MSE). In addition, equation 6 does not need to update the updated tap coefficient(s) w(n+1) unlike equation 5 so that it can directly replace ƒₑ(n) in equation 1.

Equation 7 (below) represents the second LMS algorithm that uses the estimated posteriori errors.
w(n+1)=w(n)+μEₚ(n)X(n) Equation 7

Excess mean squared errors (MSEs) ζ that result from a small step size and a big step size in a steady-state with respect to the first LMS algorithm that uses the priori error eₐ(n) of equation 4 and the second LMS algorithm that uses the estimated posteriori error E^{p}(n) of equation 7 are equal to equations 8 and 9 (below), respectively. In equations 8 and 9, Tr(R) represents a diagonal trace of an autocorrelation matrix of the data vectors X^{T}(n) input to the filter unit 110, γ(∞) represents a reflected coefficient of equation 6 when n→∞, and σ_{γ}² represents a noise power.

$$\begin{matrix}{ζ}_{large - μ}^{LMS} = \frac{{μσ}_{γ}^{2} Tr ( R )}{2 - μ Tr ( R )} ; \\ {ζ}_{ small - μ}^{LMS} = \frac{μ}{ 2} {σ}_{ γ}^{ 2} Tr ( R ) & Equation 8 \\ \begin{matrix}{ζ}_{large - μ}^{EPE - LMS} = \frac{μγ ( INF ) {σ}_{γ}^{2} Tr ( R )}{2 - μγ ( INF ) Tr ( R )} ; \\ {ζ}_{small - μ}^{EPE - LMS} = \frac{μ}{2} γ ( INF ) {σ}_{γ}^{2} Tr ( R )\end{matrix} & Equation 9\end{matrix}$$

Equation 8 corresponds to the first LMS algorithm and equation 9 corresponds to the second LMS algorithm. It can be seen from equations 8 and 9 that the second LMS algorithm that uses the estimated posteriori error E^{p}(n) has an excess MSE ζ that is less than the first LMS algorithm that uses the priori error eₐ(n), and a difference therebetween increases when the step size μ increases.

Additionally, upper bounds of the step size μ that maintain stability with respect to the algorithm of equations 4 and 7 are equal to equations 10 and 11 (below), respectively.

$$\begin{matrix}0 < {μ}_{LMS} < 2 / 3 Tr ( R ) & Equation 10 \\ 0 < {μ}_{EPE - LMS} < \text{(} γ ( INF ) \frac{2}{3 Tr ( R )} & Equation 11\end{matrix}$$

It can be seen from equation 10 and 11 that the step size bound of the second LMS algorithm that uses the estimated posteriori error E^{p}(n) is reduced by γ(∞) times as compared to the step size bound of the first LMS algorithm that uses the priori error eₐ(n). That is, the convergence rate of the second LMS algorithm with respect to the same step size becomes low.

In order to enhance a tracking performance on an arbitrary channel change of the second LMS algorithm that uses the estimated posteriori error E^{p}(n) of equation 7, the adaptive step size LMS algorithm is performed using the estimated posteriori error E^{p}(n). The adaptive step size LMS algorithm of the present embodiment is derived using a stochastic gradient method in order to obtain a power of the estimated posteriori error E^{p}(n), that is, the step size p to minimize Eₚ²(n).

Equation 12 represents the adaptive step size LMS algorithm of the present embodiment.

In this case, ρ^{EPE} represents a constant by which to adjust the convergence characteristic of the second adaptive step size algorithm, and (μₘᵢₙ, μₘₐₓ) represents the bound of the step size μ.
μ(n)=[μ(n−1)+ρ^{EPE}γ(n)E^{p}(n)Eₚ(n−1)X^{T}(n)X(n−1)]_{μ}_{ₘᵢₙ}^{μ}^{ₘₐₓ} Equation 12

The adaptive step size LMS algorithm of the present embodiment that uses the estimated posteriori error E^{p}(n) sequentially carries out equations 2, 6, and 12 to remove interference between symbols of the data signal having the data vectors X(n) caused by the transmission channel.

Consequently, the first adaptive step size algorithm that uses the priori error and the first LMS algorithm are used in an initial bound of convergence with the training sequence signal, and the second adaptive step size LMS algorithm in which the estimated posteriori error is used in a subsequent bound of convergence with the data signal. The initial bound of convergence and the subsequent bound of convergence may be defined in terms of the step size and/or the MSE.

The channel equalizer 100 of the present embodiment enhances the channel equalization performance by increasing the convergence rate of the adaptive step size LMS algorithm while providing a low MSE, as described above.

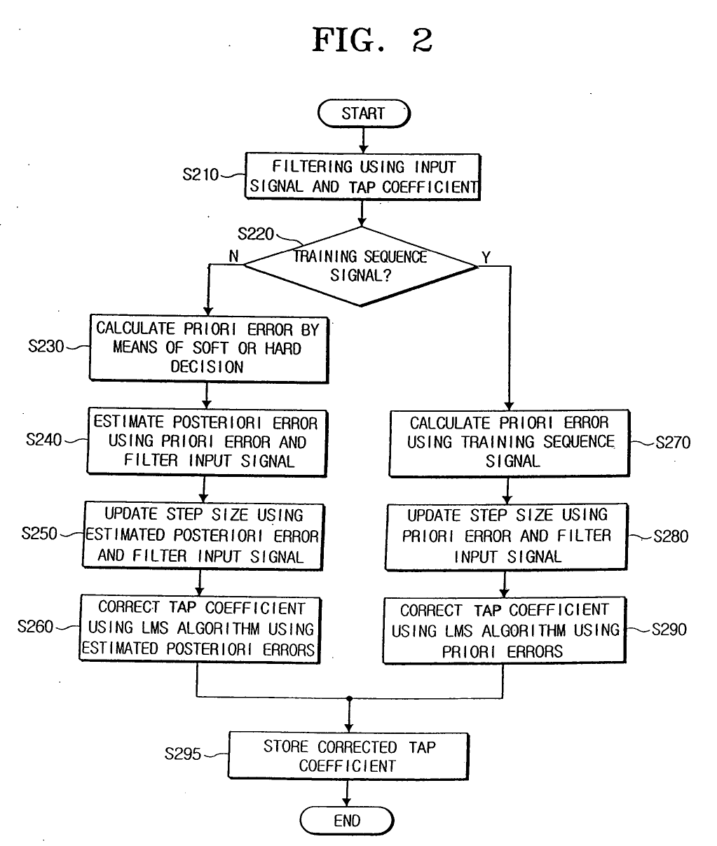

FIG. 2 is a flow chart illustrating a method of equalizing the channel in accordance with an embodiment of the present general inventive concept. The method of FIG. 2 may be performed by the channel equalizer 100 of FIG. 1. Accordingly, for illustration purposes, the method of FIG. 2 is described below with reference to FIGS. 1 and 2.

Referring to FIGS. 1 and 2, the training sequence signal and the data signal which are input to the filter unit 110 are filtered using the tap coefficient stored in the tap coefficient storage unit 120 (operation S210).

When the signal input to the filter unit 110 is the data signal (operation S220, N), the soft decision or the hard decision is made by the soft/hard decision unit 145, and the first multiplexer 130 calculates the priori error (operation S230).

The posteriori error is estimated by the posteriori error signal generation unit 155 using the calculated priori error and the data signal input to the filter unit 110 (operation S240).

The step size is updated using the estimated posteriori error and the data signal input by the filter unit 110 (operation S250). The step size may be updated according to the second adaptive step size algorithm. The tap coefficient is corrected by applying the second LMS algorithm that uses the estimated posteriori error (operation S260). The corrected tap coefficient is then stored in the tap coefficient storage unit 120 (operation S295). Additionally, the stored tap coefficient(s) may then be used by the filter unit 110.

When the signal input to the filter unit 110 is the training sequence signal, the first multiplexer 130 can be used to calculate the priori error using the training sequence signal generated by the training sequence signal generation unit 143 (operation S270). The first multiplexer 130 may instead control the priori error signal generation unit 153 to calculate the priori error.

The step size is updated using the priori error and the training sequence signal input to the filter unit 110 (operation S280). The step size may be updated according to the first adaptive step size algorithm. The tap coefficient is then corrected by applying the first LMS algorithm that uses the priori error (operation S290). The corrected tap coefficient is then stored in the tap coefficient storage unit 120 (operation S295). Additionally, the stored tap coefficient(s) may then be used by the filter unit 110.

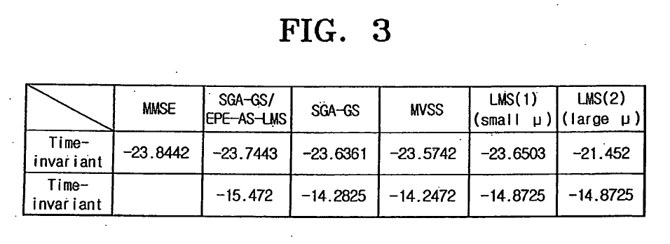

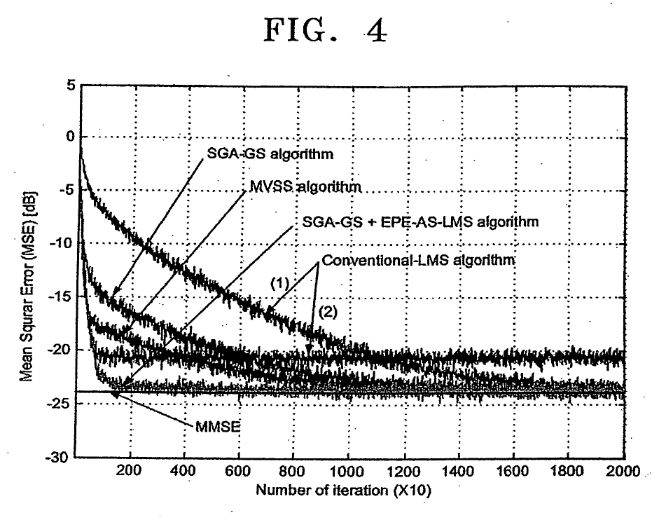

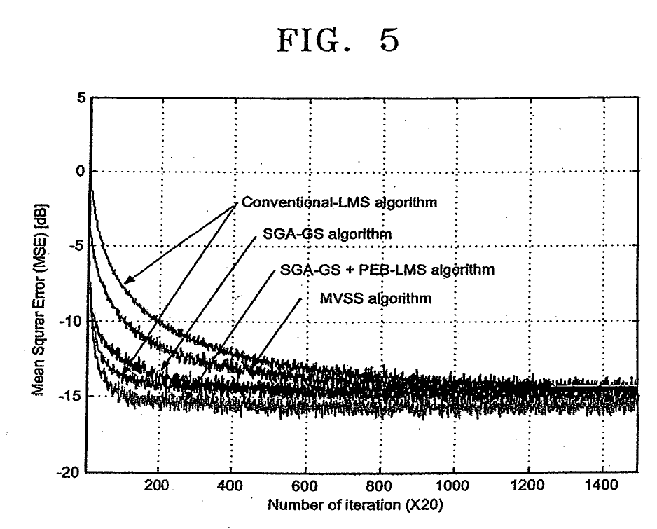

FIG. 3 is a table illustrating a steady-state MSE result comparison of various adaptive algorithms. FIGS. 4 and 5 are graphs illustrating convergence curves of channel equalizers in a time-invariant channel and a time-variant channel, respectively. Referring to FIGS. 3 to 5, an Estimated a Posteriori Error-Adaptive Step size-LMS (EPE-AS-LMS) according to the present general inventive concept, that is, the MSE of the adaptive step size LMS algorithm that uses the estimated posteriori error (i.e., the second adaptive step size algorithm and the second LMS algorithm) is the lowest. As illustrated in FIGS. 4 and 5, in the time invariant channel the MSE of the EPE-AS LMS algorithm converges to a minimum mean squared error (MMSE) faster than in the other adaptive algorithms. The other adaptive algorithms may be conventional adaptive algorithms, such as a modified variable step size algorithm (MVSS) or a conventional LMS algorithm. In the time variant channel, the MSE of the SGA-GS+PEB-LMS algorithm converges faster than the other adaptive algorithms according to the present general inventive concept.

Thus, the equalization algorithm with the channel change of the adaptive step size that uses the posteriori error is superior. Consequently, it can be seen that the channel equalizer 100 and the method of equalizing the channel of the embodiments of the present general inventive concept have a fast convergence rate and a low MSE as compared to other equalization algorithms.

The embodiments of the present general inventive concept can be embodied as computer readable codes on a computer readable recording medium. The computer readable recording medium may include any data storage device that can store data which can be thereafter read by a computer system. Examples of the computer readable recording medium include a read-only memory (ROM), a random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. The embodiments of the present general inventive concept may also be embodied in hardware or a combination of hardware and software.

Additionally, the various embodiments of the present general inventive concept may be implemented in a digital broadcast receiver to decode an input signal having a plurality symbols and to equalize a channel.

As described above, the adaptive step size LMS algorithm of the various embodiments of the present general inventive concept is employed to provide a low MSE and a fast convergence rate, so that an effective channel equalization can be obtained.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A channel equalizer, comprising:
a filter unit to filter an input training sequence signal and an input data signal according to a tap coefficient;
a decision unit to generate the training sequence signal and to soft-determine or hard-determine an output signal of the filter unit;
a first multiplexer to calculate a priori error of each of the training sequence signal and the data signal;
an error signal generation unit to generate a priori error signal using an output signal of the first multiplexer and to generate an estimated posteriori error signal using the generated priori error signal;
a first correction unit to correct a first adaptive step size algorithm using the signal input to the filter unit and the generated priori error signal and to correct a second adaptive step size algorithm using the signal input to the filter unit and the generated estimated posteriori error signal; and
a second multiplexer to select one of the corrected first adaptive step size algorithm and the corrected second adaptive step size algorithm to be applied to the training sequence signal and the data signal, respectively.

2. The channel equalizer according to claim 1, further comprising:
a second correction unit to correct a first Least Mean Square (LMS) algorithm using the generated priori error signal and an adaptive step size and to correct a second LMS algorithm using the estimated posteriori error signal and the adaptive step size; and
a third multiplexer to select one of the corrected first LMS algorithm and the corrected second LMS algorithm to be applied to the training sequence signal and the data signal, respectively.

3. The channel equalizer according to claim 1, wherein the error signal generation unit estimates the posterior error based on the generated priori error signal, a norm of data filtered by the filter unit, and a step size.

4. The channel equalizer according to claim 1, wherein a step size is updated to an adaptive step size by the second adaptive step size algorithm using the generated estimated posteriori error signal and the signal input to the filter unit.

5. The channel equalizer according to claim 4, wherein the first correction unit corrects the second adaptive step size algorithm using the estimated posteriori error signal, the signal input to the filter unit, and the adaptive step size.

6. The channel equalizer according to claim 1, wherein the second correction unit corrects the second LMS algorithm using the estimated posteriori error signal, the signal input to the filter unit, and a step size.

7. The channel equalizer according to claim 1, wherein a first adaptive step size LMS algorithm that uses the priori error and a second adaptive step size LMS algorithm that uses the estimated posteriori error are sequentially applied.

8. The channel equalizer according to claim 7, wherein the first adaptive step size LMS algorithm and the second adaptive step size LMS algorithm are applied in bounds of the training sequence signal and the data signal, respectively.

9. A channel equalizer to equalize a channel, comprising:
a filter unit to filter an input signal and having a current plurality of tap coefficients, and the input signal having a training sequence portion and a data portion; and
a correction unit to adjust the current plurality of tap coefficients according to a first adaptive step size LMS algorithm based on a priori error of the input signal when the data portion of the input signal is received by the filter unit, and adjusting the current plurality of tap coefficients according to a second adaptive step size LMS algorithm based on an estimated posteriori error of the input signal when the training sequence portion of the input signal is received by the filter unit.

10. The channel equalizer of claim 9, wherein the correction unit comprises:
a first correction unit to adjust a step size by which the plurality of tap coefficients are adjustable according to:
μ(n)=[μ(n−1)+ρ^{SGA-GA}eₐ(n)eₐ(n−1)X^{T}(n)X(n−1)]_{μ}_{ₘᵢₙ}^{μ}^{ₘₐₓ} when the data portion of the input signal is received by the filter unit, where μ(n) is the adjusted step size, μ(n−1) is a previous step size, ρ^{SGA-GA} represents a first step constant by which convergence characteristics are adjusted in the first adaptive step size LMS algorithm, eₐ(n) represents a current priori error, X(n−1) represents a previous input data vector, and X(n)^{T} represents a current input data vector, and μₘₐₓ and μₘᵢₙ represent bounds of the adjusted step size, and to adjust the step size according to:
μ(n)=[μ(n−1)+ρ^{EPE}γ(n)Eₚ(n)Eₚ(n −1)X^{T}(n)X(n−1)]_{μ}_{ₘᵢₙ}^{μ}^{ₘₐₓ}
when the training sequence portion of the input signal is received by the filter unit, where ρ^{EPE} represents a second step constant by which convergence characteristics are adjusted in the second adaptive step size LMS algorithm, Eₚ(n) represents a current estimated posteriori error signal.

11. The channel equalizer of claim 10, wherein the correction unit further comprises:
a second correction unit to adjust the plurality of tap coefficients of the filter unit according to the adjusted step size and one of the priori error signal and the estimated posteriori signal according to whether the data portion or the training sequence portion are received by the filter unit, respectively.

12. A channel equalizer to equalize a channel, comprising:
a filter unit to receive an input signal X(n) as one of a training sequence signal and a data signal and to filter the input signal according to a plurality of filter taps;
an error signal generation unit to determine a priori error signal eₐ(n) for the filtered input signal and to determine an estimated posteriori error signal E^{p}(n) according to the determined priori error signal e^{a}(n); and
a correction unit to adjust a plurality of tap coefficients associated with the plurality of filter taps according to w(n+1)=w(n)+μ(n)*eₐ(n)*X(n) when the training sequence signal is received by the filter unit, where w(n+1) represents the adjusted plurality of tap coefficients, w(n) represents a current plurality of tap coefficients, μ(n) represents an adaptive step size, and adjusting the plurality of tap coefficients associated with the plurality of filter taps according to w(n+1)=w(n)+μ(n)*E^{p}(n)*X(n) when the data signal is received by the filter unit.

13. A digital broadcast receiver, comprising:
a channel equalizer to equalize a channel, the channel equalizer including:
a filter unit to filter an input signal and having a current plurality of tap coefficients, and the input signal having a training sequence portion and a data portion; and
a correction unit to adjust the current plurality of tap coefficients according to a first adaptive step size LMS algorithm based on a priori error of the input signal when the data portion of the input signal is received by the filter unit, and adjusting the current plurality of tap coefficients according to a second adaptive step size LMS algorithm based on an estimated posteriori error of the input signal when the training sequence portion of the input signal is received by the filter unit.

14. A method of equalizing a channel, comprising:
filtering an input training sequence signal and a data signal using a tap coefficient;
calculating a priori error using the training sequence signal;
updating a step size using the calculated priori error and the input training sequence signal;
correcting the tap coefficient by applying a first LMS algorithm using the priori error; and
storing the corrected tap coefficient.

15. The method according to claim 14, further comprising:
soft-determining/hard-determining the input data signal and calculating the priori error;
estimating a posteriori error using the calculated priori error and the input data signal;
updating the step size using the estimated posteriori error and the input data signal; and
correcting the tap coefficient by applying a second LMS algorithm using the estimated posteriori error.

16. A method of equalizing a channel, the method comprising:
filtering an input signal having a plurality of symbols in a filter unit having a current plurality of tap coefficients, and the input signal having a training sequence portion and a data portion; and
adjusting the current plurality of tap coefficients according to a first adaptive step size LMS algorithm based on a priori error of the input signal when the data portion of the input signal is received by the filter unit, and adjusting the current plurality of tap coefficients according to a second adaptive step size LMS algorithm based on an estimated posteriori error of the input signal when the training sequence portion of the input signal is received by the filter unit.

17. A method of equalizing a channel, the method comprising:
receiving an input signal X(n) as one of a training sequence signal and a data signal;
filtering the input signal according to a plurality of filter taps;
determining a priori error signal e^{a}(n) for the filtered input signal;
determining an estimated posteriori error E^{p}(n) signal according to the determined priori error signal e^{a}(n); and
adjusting a plurality of tap coefficients associated with the plurality of filter taps according to w(n+1)=w(n)+μ(n)*e^{a}(n)*X(n) when the training sequence signal is received, where w(n+1) represents the adjusted plurality of tap coefficients, w(n) represents a current plurality of tap coefficients, μ(n) represents an adaptive step size, and adjusting the plurality of tap coefficients associated with the plurality of filter taps according to w(n+1)=w(n)+μ*E^{p}(n)*X(n) when the data signal is received.

18. A method of equalizing a channel, the method comprising:
receiving and filtering an input signal according to a plurality of tap coefficients; and
applying a first adaptive step size LMS algorithm to the plurality of tap coefficients when operation of a filter unit is in an initial bound of convergence and applying a second adaptive step size LMS algorithm to the plurality of tap coefficients when the operation of the filter unit is in a subsequent bound of convergence.

19. The method of claim 18, wherein the initial and subsequent bounds of convergence are defined by one of a minimum squared error (MSE) and a step size.

20. The method of claim 18, wherein the initial and subsequent bounds correspond to a training signal and a data signal, respectively.

21. A computer readable medium containing executable code to equalize a channel, the medium comprising:
a first executable code to filter an input training sequence signal and a data signal using a tap coefficient;
a second executable code to calculate a priori error using the training sequence signal;
a third executable code to update a step size using the calculated priori error and the input training sequence signal;
a fourth executable code to correct the tap coefficient by applying a first LMS algorithm using the priori error; and
a fifth executable code to store the corrected tap coefficient.
